(19) United States
(12) Patent Application Publication
(10) Pub. No.: US 2006/0130512 A1
(43) Pub. Date: Jun. 22, 2006

(54) Cooling-cycle device and cold/hot water dispenser comprising the same

(75) Inventor: Seung Don Seo, Suwon-Si (KR)

Correspondence Address: LADAS & PARRY, 26 WEST 61ST STREET, NEW YORK, NY, 10023, US

(73) Assignee: SAMSUNG GWANGJU ELECTRONICS CO., LTD.

(21) Appl. No.: 11/273,389

(22) Filed: Nov. 14, 2005

(30) Foreign Application Priority Data
Dec. 22, 2004 (KR) P2004-110723

(51) Int. Cl. B67D 5/62; F25B 1/00

(52) U.S. Cl. 62/389; 62/498

(57) ABSTRACT

A cooling-cycle device and a cold/hot water dispenser comprising the same are disclosed. The cold/hot water dispenser includes a water supply source and a cooling-cycle device in a main body to cool water of the water supply source. The cooling-cycle device includes a compressor, a condenser, an expansion unit, and an evaporator arranged to constitute a closed circuit through a refrigerant pipe and to allow the water from the water supply source to be cooled by the evaporator. The compressor comprises a closed container, a compressing unit including a compressing compartment to perform compression of refrigerant, a driving unit including a low-speed motor having four poles or more to supply compressing power according to the compression of the refrigerant, and a turbocharger to increase the amount of the refrigerant flowing to the compressing compartment. Even with the low-speed motor employed as the driving unit, the compressor can remarkably reduce operational noise without deteriorating cooling capability.

### BACKGROUND OF THE INVENTION

1. Field of the Invention

The present invention relates to a cooling-cycle device, and a cold/hot water dispenser comprising the same. More particularly, the present invention relates to a cooling-cycle device, which includes a low-speed motor, and a compressor adapted to prevent deterioration in compressing capability of refrigerant, remarkably lowering operational noise without deterioration in cooling capability of the cooling-cycle device, and a cold/hot water dispenser comprising the same.

2. Description of the Related Art

Generally, a cold/hot water dispenser dispenses cold/hot water-from a main body having a cold water tank and a hot water tank, a cooling-cycle device to cool water in the cold water tank, and a heater to heat water in the hot water tank.

The cooling-cycle device includes a compressor to discharge high pressure refrigerant after suctioning low pressure refrigerant and compressing the refrigerant to have the high pressure, a condenser to condense the refrigerant discharged from the compressor, an expansion unit to expand the refrigerant condensed through the condenser, and an evaporator to perform heat exchange of the refrigerant with surrounding gas through evaporation of the refrigerant expanded by the evaporator, which constitute a closed circuit through a refrigerant pipe. In the cooling-cycle device, the evaporator is wound around the cold water tank to effectively absorb heat from the cold water tank.

Accordingly, while circulating through the cooling-cycle device, the refrigerant is condensed in the condenser to emit heat, and is then evaporated in the evaporator to absorb heat from the cold water tank. Thus, the water of the cold water tank is cooled by the evaporator, and is then dispensed in this state to an outside of the main body.

Meanwhile, the compressor of the cooling-cycle device includes a compressing unit to perform compression of the refrigerant, and a motor to supply a compressing power according to compression of the refrigerant in a closed container. The closed container is provided with a suction pipe to deliver the refrigerant from the evaporator into the closed container, and a discharge pipe to deliver the refrigerant compressed by the compressing unit to the condenser.

With such a construction as described above, after driving the motor, the refrigerant flowing from the evaporator to the closed container of the compressor through the suction pipe is compressed by the compressing unit, and is then discharged in a compressed state to the condenser through the discharge pipe.

As in a typical refrigerator or an air conditioner, the compressor of the conventional cold/hot water dispenser generally employs a 2-pole motor which operates at a commercial rotational speed of 3,000˜3,600 rpm.

However, since the conventional cooling-cycle device employs the 2-pole motor of a high speed as the motor of the compressor, noise and vibration of the compressor are remarkably increased when the motor operates at a high speed, and are transmitted to the overall body of the water dispenser, thereby remarkably increasing operational noise of the water dispenser. As a result, the increased noise of the water dispenser significant deteriorates reliability of the water dispenser.

In order to lower the operating noise of the cold/hot water dispenser, a low-speed motor having two or more poles, such as a 4-pole motor, which operates at a commercial rotational speed of 1,500˜1,800 rpm, may be considered as the motor of the compressor. However, in this case, the compressing capability of the compressor is lowered due to reduction in rotational speed of the motor, so that the compressor cannot smoothly perform compression of the refrigerant, thereby remarkably deteriorating the cooling capability of the cold/hot water dispenser.

### SUMMARY OF THE INVENTION

Accordingly, it is an aspect of the present invention to provide a cooling-cycle device, which includes a low-speed motor, and a compressor adapted to prevent deterioration in compressing capability of refrigerant, remarkably lowering operational noise without deterioration in cooling capability of the cooling-cycle device, and a cold/hot water dispenser comprising the same.

Additional aspects and/or advantages of the invention will be set forth in part in the description which follows and, in part, will be apparent from the description, or may be learned by practice of the invention.

In accordance with one aspect of the present invention, a cooling-cycle device is provided, including a compressor, a condenser, an expansion unit, and an evaporator arranged to constitute a closed circuit through a refrigerant pipe, wherein the compressor comprises a closed container, a compressing unit including a compressing compartment to perform compression of refrigerant, a driving unit including a low-speed motor having four poles or more to supply compressing power according to the compression of the refrigerant, and a turbocharger to increase an amount of the refrigerant flowing to the compressing compartment.

In accordance with another aspect of the present invention, a cold/hot water dispenser is provided, including a water supply source and a cooling-cycle device in a main body to cool water of the water supply source, the cooling-cycle device including a compressor, a condenser, an expansion unit, and an evaporator arranged to constitute a closed circuit through a refrigerant pipe and to allow the water from the water supply source to be cooled by the evaporator, wherein the compressor comprises a closed container, a compressing unit including a compressing compartment to perform compression of refrigerant, a driving unit including a low-speed motor having four poles or more to supply compressing power according to the compression of the refrigerant, and a turbocharger to increase an amount of the refrigerant flowing to the compressing compartment.

The turbocharger may receive a driving force from the driving unit to compress the refrigerant within the closed container into the compressor.

The driving unit may comprise a stator fixed within the closed container, a rotor positioned in the stator, and a rotational shaft fitted into the rotor, the compressing unit may comprise a cylinder defining the compressing compartment therein, a piston positioned in the compressing compartment to move linearly in the compressing compartment, and a connecting rod connected between an eccentric shaft provided at one end of the rotational shaft and the piston, and the turbocharger may comprise an assistant cylinder defining a charging compartment therein, an assistant piston positioned in the charging compartment to move linearly in the charging compartment, an assistant connecting rod connected between the eccentric shaft and the assistant piston, a suction passage to communicate the closed container with the charging compartment, and a discharge passage to communicate the charging compartment with the compressing compartment.

The assistant piston may reach top dead center before the piston reaches top dead center.

The assistant piston may reach bottom dead center in a state of the piston reaching top dead center, and may reach top dead center in a state of the piston reaching its bottom dead center.

The suction passage and the discharge passage may include a suction valve and a discharge valve such that the suction passage and the discharge passage are oppositely opened and closed by the suction valve and the discharge valve, respectively.

The driving unit may be a 4-pole motor.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a perspective view illustrating the appearance of a cold/hot water dispenser in accordance with an embodiment of the present invention;

FIG. 2 is a schematic view illustrating the inner construction of the cold/hot water dispenser;

FIG. 3 is a cross-sectional view illustrating an overall construction of a compressor in a cooling-cycle device of the cold/hot water dispenser;

FIG. 4 is a horizontal cross-sectional view illustrating an overall construction of a compressor in a cooling-cycle device of the cold/hot water dispenser;

FIG. 5 is a cross-sectional view illustrating a turbocharger of the cold/hot water dispenser, in which refrigerant in a closed container flows into a charging compartment;

FIG. 6 is a cross-sectional view illustrating the turbocharger of the cold/hot water dispenser, in which the refrigerant in the charging compartment flows into a compressing compartment;

FIG. 7 is a perspective view illustrating a vane for oil pickup in the compressor of the cold/hot water dispenser; and

FIG. 8 is a horizontal cross-sectional view illustrating the vane for oil pickup in the compressor of the cold/hot water dispenser.

### DETAILED DESCRIPTION OF THE PREFERRED EMBODIMENTS

The disclosure of Korean Patent Application No. 2004-110723, filed on Dec. 22, 2004, is incorporated herein by reference.

Reference will now be made in detail to the embodiments of the present invention, examples of which are illustrated in the accompanying drawings, wherein like reference numerals refer to the like elements throughout the drawings. The embodiments are described below to explain the present invention by referring to the figures.

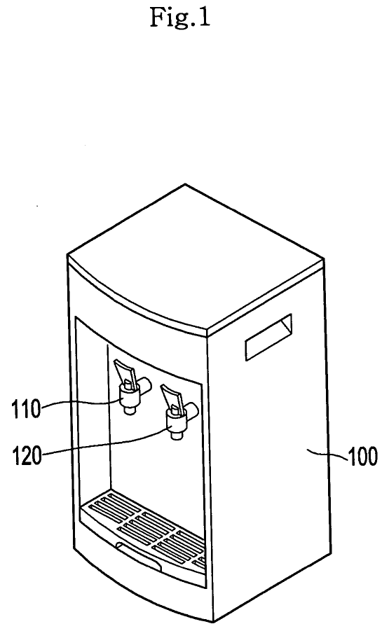

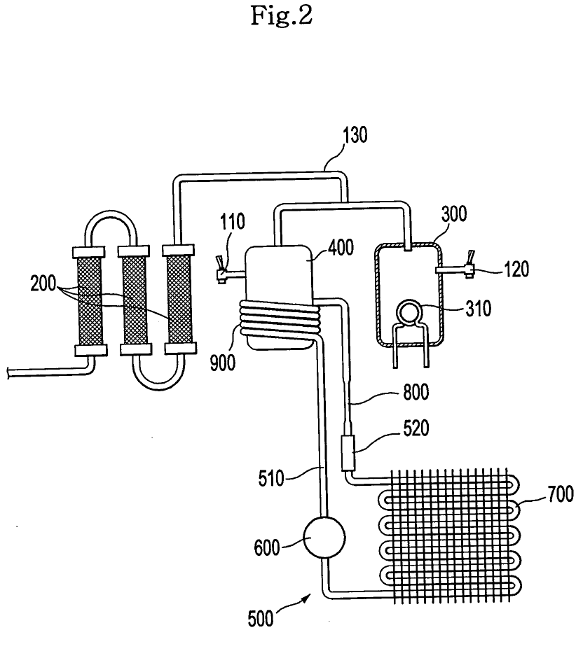

A cold/hot water dispenser according to one embodiment of the present invention comprises a typical purified cold/hot water dispenser. As shown in FIGS. 1 and 2, the cold/hot water dispenser comprises a parallelepiped main body 100 defining the outer appearance thereof, and cold and hot water faucets 110 and 120 positioned on an upper front side of the main body 100 to dispense cold and hot water to a user therethrough, respectively.

The main body 100 comprises a filter assembly 200 to remove various foreign matter and bacteria contained in water transferred from an external water source (not shown) into the main body 100, and hot and cold water tanks 300 and 400 to contain the hot water and the cold water, respectively.

The filter assembly 200 can be omitted if a purifying function is not required in the cold/hot water dispenser of the present invention. The cold water tank 400 is a water source positioned in the main body, and in this embodiment, a typical water tank can be provided as the cold water tank 400. Alternatively, when the cold/hot water dispenser is adapted to directly supply the water to the outside without containing the water supplied from the external water source therein, the cold water tank 400 can have a typical pipe shape connected to the external water source.

The filter assembly 200 is connected to a water supply pipe 130 which is bifurcated to the hot water tank 300 and the cold water tank 400, so that water is supplied to the hot water tank 300 and the cold water tank 400 through the water supply pipe 130 after passing through the filter assembly 200. Outlets of the hot water tank 300 and the cold water tank 400 are connected to the hot and cold water faucets 120 and 110, respectively.

The hot water tank 300 comprises a heater 310 to heat water in the hot water tank 300, and the cold water tank 400 comprises a cooling-cycle device 500 to cool the water therein. The cooling-cycle device 500 comprises a compressor 600, a condenser 700, an expansion unit 800, and an evaporator 900 which are arranged to constitute a closed circuit through a refrigerant pipe 510.

The compressor 600 compresses refrigerant into a high temperature and high pressure gaseous refrigerant, and the condenser 700 condenses the gaseous refrigerant from the compressor into a liquid refrigerant of high temperature and high pressure. The liquid refrigerant of high temperature and high pressure from the condenser 700 is subjected to throttling expansion into a liquid refrigerant of low temperature and low pressure through the expansion unit 800. Then, the evaporator 900 evaporates the liquid refrigerant of low temperature and low pressure passing through the expansion unit 800 into a gaseous refrigerant of low temperature and low pressure.

Thus, while circulating along the refrigerant pipe 510 of the cooling-cycle device 500, the refrigerant is condensed by the condenser 700 to dissipate its heat to the surroundings, and is evaporated by the evaporator 900 to absorb heat from the surroundings, in which the cooling-cycle device 500 performs a cooling operation through the evaporator 900.

The evaporator 900 is wound around the cold water tank 400 to effectively absorb heat from the cold water tank 400. A drier 520 is positioned on the refrigerant pipe 510 between the condenser 700 and the expansion unit 800 to remove moisture from the liquid refrigerant which has passed through the condenser.

With the construction described above, when the cooling-cycle device 500 and the heater 310 are driven, the water of the cold water tank 400 is cooled by the evaporator 900 of the cooling-cycle device 500 while the water of the hot water tank 300 is heated by the heater, so that cold and hot water can be dispensed to the outside of the main body 100 via an operation of the cold and hot water faucets 110 and 120 on the front surface of the main body 100 by a user.

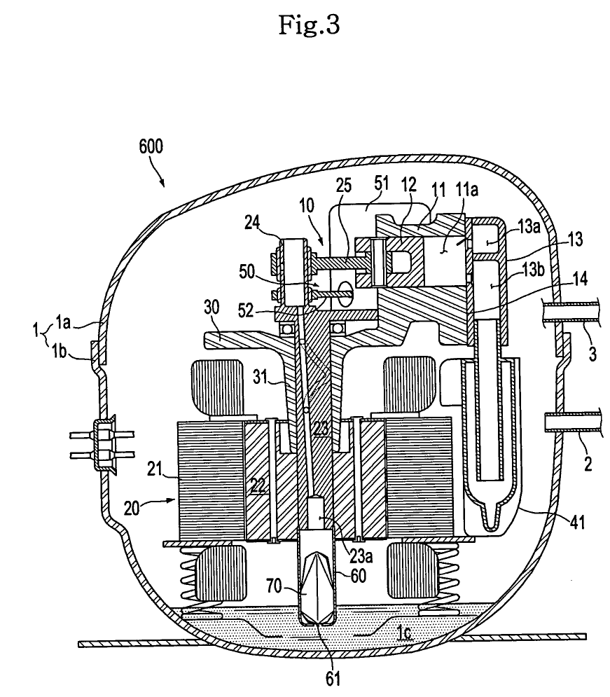

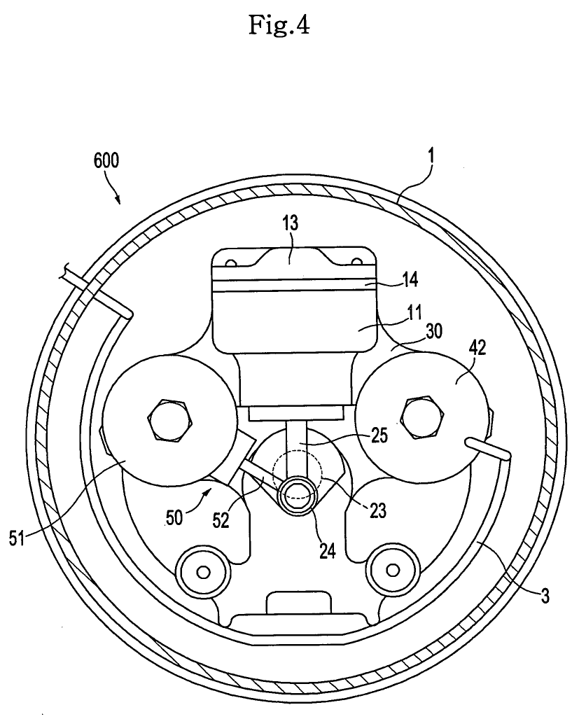

As shown in FIGS. 3 and 4, the compressor 600 comprises a closed container 1 formed by coupling an upper container 1a and a lower container 1b, a compressing unit 10 positioned in the closed container 1 to perform compression of the refrigerant, and a driving unit 20 to supply compressing power according to the compression of the refrigerant. The closed container 1 is provided, at one side, with a suction pipe 2 to guide the refrigerant in the evaporator 900 of the cooling-cycle device 500 into the closed container 1, and at the other side, with a discharge pipe 3 to discharge the refrigerant compressed by the compressing unit 10 to the condenser 700 of the cooling-cycle device 500 located at the outside of the closed container 1. The suction pipe 2 and the discharge pipe 3 are connected to the refrigerant pipe 510.

The compressing unit 10 comprises a cylinder 11 defining a compressing compartment 11a therein to compress the refrigerant, a piston 12 positioned in the compressing compartment 11a to perform compression of refrigerant while moving linearly therein, and a cylinder head 13 coupled to the cylinder 11 to close the compressing compartment 11a and having a refrigerant discharge compartment 13a and a refrigerant suction compartment 13b partitioned therein. The compressing unit 10 further comprises a valve assembly 14 positioned between the cylinder 11 and the cylinder head 13 to control flow of the refrigerant which is suctioned from the refrigerant suction compartment 13b to the compressing compartment 11a or discharged from the compressing compartment 11a to the refrigerant discharge compartment 13a. The cylinder 11 is provided in the cylinder block 30 positioned on a stator.

The driving unit 20 supplies a driving force to the piston 12 so as to allow the piston 12 to reciprocate in the compressing compartment 11a. The driving unit 20 is embodied by a typical motor which comprises the stator 21 fixed within the closed container 1, a rotor 22 positioned in the stator 21 while being separated from the stator 21 to electrically cooperate with the stator 21, and a rotational shaft 23 fitted into a center of the rotor 22 to rotate together with the rotor 22. A 4-pole motor operates at a commercial rotational speed of 1,500˜1,800 rpm at a frequency of 50˜60, and is employed as the motor of the present invention. For this purpose, a 4-pole stator is employed as the stator 21.

According to the present invention, since the low-speed 4-pole motor is used as the driving unit 20 in the compressor 600, rotational speed of the rotational shaft 23 becomes about half of that of a 2-pole motor employed in a cooling-cycle device for a typical conventional cold/hot water dispenser, so that vibration caused by rotation of the motor is remarkably reduced. As a result, operational noise of the compressor 600 is reduced to such a level that the noise of the compressor 600 is substantially removed at the outside of the closed container 1, so that the operational noise from the cooling-cycle device 500 and the cold/hot water dispenser comprising the driving unit of the invention can be remarkably reduced.

The rotational shaft 23 is supported by bearings 31 positioned in the cylinder block 30, and extends upwardly. The rotational shaft 23 is provided at an upper portion thereof with an eccentric shaft 24 which rotates in an eccentric state, and a connecting rod 25. One end of the connecting rod 25 is rotatably connected with the eccentric shaft 24, and the other end thereof is connected with the piston 12 to allow rotation and linear movement of the connecting rod 25 so as to convert eccentric rotation of the eccentric shaft 24 into a linear movement thereof.

A suction muffler 41 is positioned between the refrigerant suction compartment 13b and the suction pipe 2 to reduce flow noise of the refrigerant flowing to the compressing compartment 1a. A discharge muffler 42 (see FIG. 4) is positioned between the refrigerant discharge compartment 13a and the discharge pipe 3 to form a resonance space for reducing discharge noise of the refrigerant discharged to the outside of the closed container 1. The discharge muffler 42 is integrated with the cylinder block 30 at one side of the cylinder 11 which is integrated with the cylinder block 30.

With such a construction as described above, when the rotational shaft 23 rotates together with the rotor 22 by electric cooperation of the stator 21 and the rotor 22 via application of power, the piston 12 connected with the eccentric shaft 24 via the connecting rod 25 linearly moves in the compressing compartment 11a. Thereby, the refrigerant having flown from the suction pipe 2 to the closed container 1 is introduced to the refrigerant suction compartment 13b of the cylinder head 13 with the flow noise of the refrigerant reduced to some degree while passing through the suction muffler 41, and is then transferred to the compressing compartment 11a to be compressed therein. The refrigerant compressed by the compressing compartment 11a is discharged to the outside of the closed container 1 through the discharge muffler 42 and the discharge pipe 3 after passing through the refrigerant discharge compartment 13a of the cylinder head 13. With processes as described above repeated, the refrigerant is compressed by the compressor 600.

A turbocharger 50 is provided to the cylinder block 30 at the other side of the cylinder 11 to increase the amount of the refrigerant flowing to the compressing compartment 11a, which compensates for reduction in compressing capability of the compressor 600 caused by reduction in rotational speed of the rotational shaft 23. The turbocharger 50 enables the compressor 600 to satisfy the compression capability of the refrigerant required for the cooling-cycle device of the typical cold/hot water dispenser while the low-speed 4-pole motor is used as the driving unit 20, thereby preventing cooling capability of the cooling-cycle device 500 and the cold/hot water dispenser from being deteriorated.

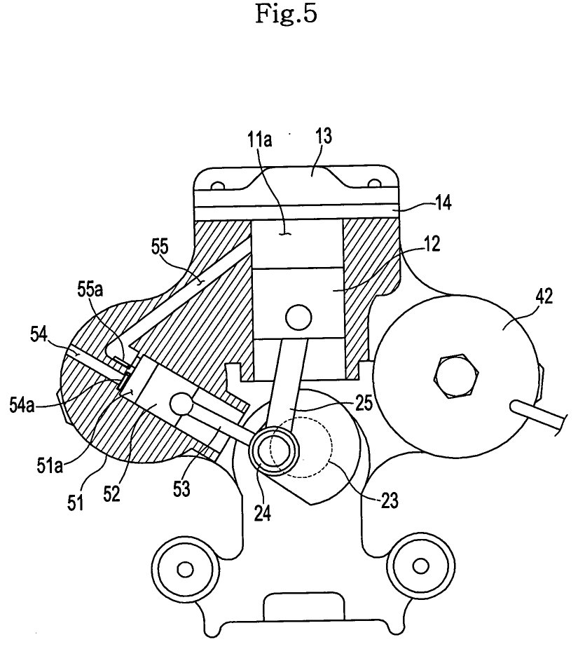

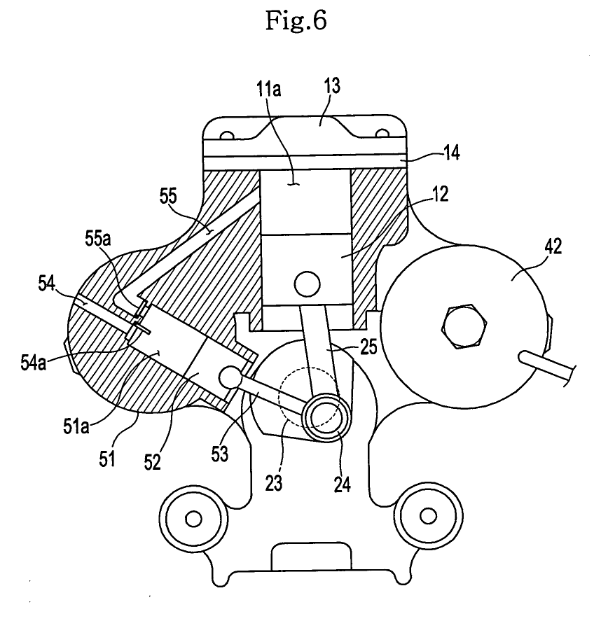

In addition, the turbocharger 50 compresses the refrigerant present in the closed container 1 without flowing to the refrigerant suction compartment 13b of the cylinder head 13 through the suction muffler 41 among the refrigerant flowing to the closed container 1 through the suction pipe 2, and supplies the compressed refrigerant to the compressing compartment 11a, thereby increasing the amount of the refrigerant flowing into the compressing compartment 11a. The turbocharger 50 is driven by receiving the driving force of the driving unit 20 to supply the compressed refrigerant to the compressing compartment 11a by compressing the refrigerant remaining in the closed container 11 without an additional driving unit. The construction of the turbocharger 50 will be described in detail with reference to FIGS. 5 and 6.

FIG. 5 illustrates the turbocharger 50 in which the refrigerant in the closed container 1 is flowing into a charging compartment 51a, and FIG. 6 illustrates the turbocharger 50 in which the refrigerant in the charging compartment 51a is flowing to the compressing compartment 11a.

As shown in FIGS. 5 and 6, the interior of the turbocharger 50 constitutes the charging compartment 51a of the turbocharger 50. The turbocharger 50 comprises an assistant cylinder 51 integrated with the cylinder block 30 at the opposite side of the discharge muffler 42 which is also integrated with the cylinder block 30, and an assistant piston 52 positioned in the charging compartment 51a to compress the refrigerant within the compressing compartment 11a while moving linearly therein. The turbocharger 50 further comprises an assistant connecting rod 53, one end of which is connected with the assistant piston 52 to rotate in a ball-joint manner, and the other end of which is rotatably connected with the eccentric shaft 24 of the rotational shaft 23 along with the connecting rod 25 to have a predetermined angle to the connecting rod 25. The turbocharger 50 further comprises a suction passage 54 to communicate the closed container 1 with the charging compartment 51a, and a discharge passage 55 to communicate the charging compartment 51a with the compressing compartment 11a.

The suction passage 54 penetrates the assistant cylinder 51, and communicates the closed container 1 with the charging compartment 51a, and the discharge passage 55 penetrates the cylinder block 30 between the charging compartment 51a and the compressing compartment 11a to communicate the charging compartment 51a with the compressing compartment 11a. An outlet of the suction passage 54 and an inlet of the discharge passage 55 are formed on a closed end of the charging compartment 51a located at a side of the top dead center of the assistant piston 52.

An assistant suction valve 54a is positioned at the outlet of the suction passage 54 to open the suction passage 54 when the assistant piston 52 moves to the bottom dead center, and to close the suction passage 54 when the assistant piston 52 moves to the top dead center. An assistant discharge valve 55a is positioned at the inlet of the discharge passage 55 to close the discharge passage 55 when the assistant piston 52 moves to the bottom dead center, and to open the discharge passage 54 when the assistant piston 52 moves to the top dead center. As such, the assistant suction and discharge valves 54a and 55a are provided to the suction passage 54 and the discharge passage 55 to oppositely open and close the suction passage 54 and the discharge passage 55, respectively.

The operation of the piston 12 and the assistant piston 52 is performed such that the assistant piston 52 reaches top dead center before the piston 12 reaches top dead center, so that the refrigerant compressed by the turbocharger 50 is supplied to the compressing compartment 11a before the refrigerant is discharged from the compressing unit 10 to the refrigerant discharge compartment 13a. For more effective charging of the refrigerant, it is preferable that the assistant piston 52 substantially reach bottom dead center in a state of the piston 12 reaching top dead center, and the assistant piston 52 substantially reach the top dead center in a state of the piston 12 reaching the bottom dead center. For this purpose, a length of the connecting rod 25 or the assistant connecting rod 53, or the angle therebetween can be adjusted. Alternatively, although the eccentric shaft 24 extends coaxially in the present embodiment, it can be formed into two stages having different axes such that the ends of the connecting rod 25 and the assistant connecting rod 53 are coupled with associated ends of the eccentric shaft 24, respectively.

Thus, according to the present invention, while compressing the refrigerant via rotation of the rotational shaft 23, the compressor 600 of the cooling-cycle device 500 allows the refrigerant present in the closed container 1 to be compressed and supplied to the compressing compartment 11a by the turbocharger 50, and thus increases the amount of the refrigerant flowing into the compressing compartment 11a. As a result, the compressor 600 can prevent the compressing capability from being lowered due to low speed rotation of the rotational shaft 23 while employing the low-speed 4-pole motor as the driving unit 20.

In addition, referring to FIG. 3, an oil storage space 1c is formed on the bottom of the closed container 1 to store a predetermined amount of oil. The rotational shaft 23 comprises an oil passage 23a formed therein to supply the oil in the oil storage space 1c to the rotational shaft 23 or a frictional area of the compressing unit 10, and an oil pickup member 60 formed at a lower end thereof to communicate the oil storage space 1c with the oil passage 23a.

The oil pickup member 60 is coupled with the rotational shaft 23 by press fitting an open upper end of the oil pickup member 60 into the lower end of the rotational shaft 23. The oil pickup member 60 comprises an oil supply hole 61 formed at a center of the lower end, and a plate-shaped vane 70 provided therein to enhance oil pickup by generating an eddy current between the vane 70 and an interior surface of the oil pickup member 60.

Thus, the oil lubricates and cools the compressor while being transferred from the oil storage space 1c to the frictional area of the rotational shaft 23 or the compressing unit 10 along the interior surface of the oil pickup member 60 and the oil passage 23a.

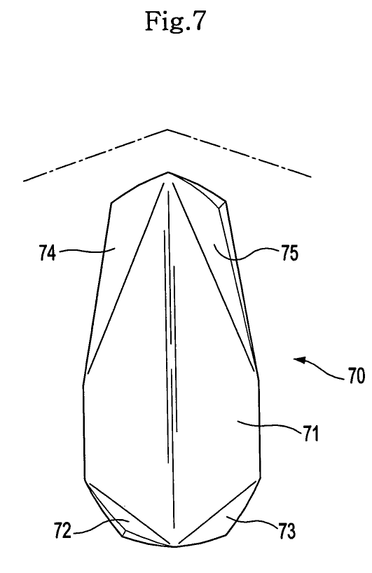

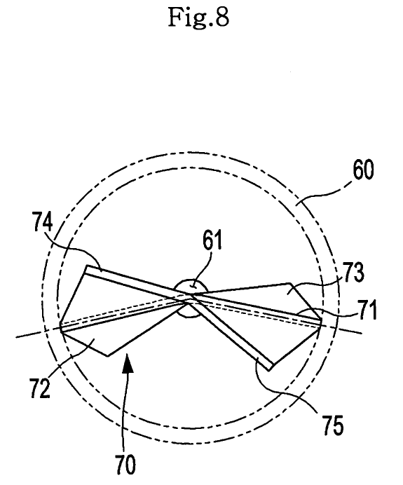

As shown in FIGS. 7 and 8, the vane 70 comprises a body 71 formed at a center thereof, and bent portions 72, 73, 74 and 75 formed at upper and lower edges of the vane 70. The bent portions 72, 73, 74 and 75 comprise a pair of lower bent portions 72 and 73 formed at both lower edges and bent towards a rotational direction of the rotational shaft 23, and a pair of upper bent portions 74 and 75 formed at both upper edges and bent opposite to the rotational direction of the rotational shaft 23.

The bent portions 72, 73, 74 and 75 prevent oil pickup efficiency from being deteriorated due to operation of the low-speed motor, and enable the oil in the oil storage space 1c to be effectively picked up by the rotational shaft 23 which rotates at a low speed.

In other words, during the rotation of the rotational shaft 23, the lower bent portions 72 and 73 bent towards the rotational direction of the rotational shaft 23 enable the oil to be more effectively picked up, and the upper bent portions 74 and 75 enables the upwardly guided oil to be rapidly guided vertically before the oil is guided to an upper distal end of the vane 70, so that an oil pickup operation can be effectively performed even though the rotational shaft 23 rotates at the lower speed.

Considering the commercial rotational speed of the 4-pole motor, it is preferable that the lower bent portions 72 and 73 and the upper bent portions 74 and 75 have bent angles of 30 degrees and 40 degrees, respectively. Thus, with both sides bent into a round shape with respect to the center of the vane 70, the vane 70 is press-fitted in place to the oil pickup member 60.

Thus, with the vane 70 constructed as described above, the compressor of the present invention can prevent the oil pickup operation from being deteriorated due to the low speed rotation of the rotational shaft 23 while employing the low-speed 4-pole motor as the driving unit 20.

An operation and advantageous effect of the compressor 600 of the cooling-cycle device 500 according to the present invention will be described as follows.

First, the rotational shaft 23 rotates together with the rotor 22 by electric cooperation of the stator 21 and the rotor 22 via application of power, the piston 12 connected with the eccentric shaft 24 via the connecting rod 25 linearly moves in the compressing compartment 11a. Thereby, refrigerant positioned outside the closed container 1 is introduced to the refrigerant suction compartment 13b of the cylinder head 13 with flow noise of the refrigerant reduced to some degree while passing from the suction pipe 2 through the suction muffler 41, and is then supplied to the compressing compartment 11a to be compressed therein. The refrigerant compressed by the compressing compartment 11a is discharged to an outside of the closed container 1 through the discharge pipe 3 after passing through the refrigerant discharge compartment 13a of the cylinder head 13. With processes as described above repeated, the refrigerant is compressed by the compressor 600. Then, while circulating through the refrigerant pipe 510, the compressed refrigerant is evaporated by the evaporator 900 to cool water in the cold water tank 400.

At this time, according to the present invention, since the low-speed 4-pole motor is used as the driving unit 20 in the compressor 600 of the cooling-cycle device 500, the rotational speed of the rotational shaft 23 becomes about half of that of the typical 2-pole motor, so that vibration caused by the rotation of the motor is remarkably reduced. As a result, operational noise of the compressor 600 is reduced to such a level that the noise of the compressor 600 is substantially removed at the outside of the closed container 1, and accordingly, the noise and vibration is not substantially transferred from the compressor 600 to the main body 100 of the cold/hot water dispenser.

In addition, the compressor 600 of the cooling-cycle device 500 enables the refrigerant in the closed container 1 to be compressed and transferred to the compressing compartment 11a by the turbocharger 50 while compressing the refrigerant, and increases an amount of the refrigerant flowing to the compressing compartment 11a, thereby preventing compressing capability thereof from being lowered due to the low speed rotation of the rotational shaft 23 even with the low-speed 4-pole motor employed as the driving unit 20. As a result, the cooling-cycle device 500 and the cold/hot water dispenser comprising the same are also prevented from being lowered in cooling capability even with the low-speed and low noise compressor 600.

Moreover, even with the low-speed 4-pole motor employed as the driving unit 20, the compressor 600 of the cooling-cycle device 500 prevents the oil pickup operation from being deteriorated due to the low speed rotation of the rotational shaft 23 via an oil pickup promoting operation by the bent portions 72, 73, 74 and 75 of the vane 70.

Although the 4-pole motor is employed as the driving unit 20 of the compressor 20 in the present embodiment, it should be noted that the driving motor can be embodied by various low-speed motors having 4 poles or more such as a 6-pole motor. Additionally, the compressor 600 of the cooling-cycle device 500 can more effectively compensate reduction in compressing capability of the compressor 600 due to employment of the low-speed motor by increasing the diameters of the compressing compartment 11a and the piston 12 or a stroke length of the piston 12 in addition to the construction of the turbocharger 50 as described above.

As apparent from the above description, the cooling-cycle device and the cold/hot water dispenser comprising the same comprise a driving unit embodied by the low-speed motor having 4 poles or more to remarkably reduce driving noise, and the compressor adapted to compensate for reduction in compressing capability due to low-speed rotation of the rotational shaft by use of a turbocharger, thereby remarkably reducing operational noise without lowering cooling capability.

Although a few embodiments of the present invention have been shown and described, it would be appreciated by those skilled in the art will that various modifications, additions and substitutions may be made in these embodiments without departing from the principle and spirit of the invention, the scope of which defined in the claims and their equivalents.

What is claimed is:

1. In a cooling-cycle device including a compressor, a condenser, an expansion unit, and an evaporator connected with piping into a closed circuit for a refrigerant,
the improvements wherein the compressor comprises a closed container having therein a compressing unit including a compressing compartment to compress the refrigerant, a driving unit including a low-speed motor having four or more poles to supply compressing power to the compressing unit according to the compression of the refrigerant, and a turbocharger to flow the refrigerant into the compressing compartment.

2. The cooling-cycle device according to claim 1, wherein the turbocharger receives a driving force from the driving unit and flows the refrigerant from the closed container into the compressing compartment.

3. The cooling-cycle device according to claim 2,
wherein the driving unit comprises a stator fixed within the closed container, a rotor positioned in the stator, and a rotational shaft fitted into the rotor,
wherein the compressing compartment comprises a cylinder and the compressing unit comprises a piston movable linearly in the compressing compartment and a connecting rod connected between an eccentric on one end of the rotational shaft and the piston, and
wherein the turbocharger comprises an assistant cylinder for defining a charging compartment therein, an assistant piston movable linearly in the charging compartment, an assistant connecting rod connected between the eccentric and the assistant piston, a suction passage to communicate the closed container with the charging compartment, and a discharge passage to communicate the charging compartment with the compressing compartment.

4. The cooling-cycle device according to claim 3, wherein the linear movements of the pistons reach top dead centers and the assistant piston reaches the top dead center thereof before the piston reaches the top dead center thereof.

5. The cooling-cycle device according to claim 4, wherein the linear movements of the pistons reach bottom dead centers and the assistant piston reaches the bottom dead center thereof as the piston reaches the top dead center thereof, and reaches the top dead center thereof as the piston reaches the bottom dead center thereof.

6. The cooling-cycle device according to claim 5, wherein the suction passage and the discharge passage respectively include suction and discharge valves such that the suction passage and the discharge passage are oppositely opened and closed

7. The cooling-cycle device according to claim 1, wherein the driving unit is a 4-pole motor.

8. A cold/hot water dispenser including a water supply source and the cooling-cycle device according to claim 1 in a main body wherein the evaporator cools water of the water supply source

9. The water dispenser according to claim 8, wherein the turbocharger receives a driving force from the driving unit and flows the refrigerant from the closed container into the compressing compartment.

10. The water dispenser according to claim 9, wherein the driving unit comprises a stator fixed within the closed container, a rotor positioned in the stator, and a rotational shaft fitted into the rotor,
wherein the compressing compartment comprises a cylinder and the compressing unit comprises a piston movable linearly in the compressing compartment and a connecting rod connected between an eccentric on one end of the rotational shaft and the piston, and
wherein the turbocharger comprises an assistant cylinder for defining a charging compartment therein, an assistant piston movable linearly in the charging compartment, an assistant connecting rod connected between the eccentric and the assistant piston, a suction passage to communicate the closed container with the charging compartment, and a discharge passage to communicate the charging compartment with the compressing compartment.

11. The water dispenser of claim 10, wherein the linear movements of the pistons reach top and bottom dead centers and the assistant piston reaches the bottom dead center thereof as the piston reaches the top dead center thereof, and reaches the top dead center thereof as the piston reaches the bottom dead center thereof.

12. The cooling-cycle device according to claim 11, wherein the suction passage and the discharge passage respectively include suction and discharge valves such that the suction passage and the discharge passage are oppositely opened and closed.

13. In a cooling-cycle device including a compressor, a condenser, an expansion unit, and an evaporator connected with piping into a closed circuit for a refrigerant, the improvements wherein:
the compressor comprises a closed container having therein a compressing unit including a compressing compartment to compress the refrigerant, a driving unit including a low-speed motor having four or more poles to supply compressing power to the compressing unit according to the compression of the refrigerant, and a turbocharger to flow the refrigerant into the compressing compartment; and
wherein the turbocharger receives a driving force from the driving unit and flows the refrigerant from the closed container into the compressing compartment.

14. In a cooling-cycle device including a compressor, a condenser, an expansion unit, and an evaporator connected with piping into a closed for a refrigerant, the improvements wherein:
the compressor comprises a closed container having therein a compressing unit including a compressing compartment to compress the refrigerant, a driving unit including a low-speed motor having four or more poles to supply compressing power to the compressing unit according to the compression of the refrigerant, and a turbocharger to flow the refrigerant into the compressing compartment;
wherein the turbocharger receives a driving force from the driving unit and flows the refrigerant from the closed container into the compressing compartment;
wherein the driving unit comprises a stator fixed within the closed container, a rotor positioned in the stator, and a rotational shaft fitted into the rotor;
wherein the compressing compartment comprises a cylinder and the compressing unit comprises a piston movable linearly in the compressing compartment and a connecting rod connected between an eccentric on one end of the rotational shaft and the piston; and
wherein the turbocharger comprises an assistant cylinder for defining a charging compartment therein, an assistant piston movable linearly in the charging compartment, an assistant connecting rod connected between the eccentric and the assistant piston, a suction passage to communicate the closed container with the charging compartment, and a discharge passage to communicate the charging compartment with the compressing compartment.

15. The cooling-cycle device according to claim 14, wherein the linear movements of the pistons reach top and bottom dead centers and the assistant piston reaches the bottom dead center thereof as the piston reaches the top dead center thereof, and reaches the top dead center thereof as the piston reaches the bottom dead center thereof.

16. The cooling-cycle device according to claim 15, wherein the suction passage and the discharge passage respectively include suction and discharge valves such that the suction passage and the discharge passage are oppositely opened and closed.
